(19) United States
(12) Patent Application Publication
(10) Pub. No.: US 2008/0307849 A1
(43) Pub. Date: Dec. 18, 2008

(54) Method And Apparatus For Forming Microstructures

(75) Inventors: Chee Yen Lim, Singapore (SG); Yuan Xu, Singapore (SG); Hbaieb Kais, Singapore (SG); Yuan Ling Christina Tan, Singapore (SG)

Correspondence Address: C. JAMES BUSHMAN, 5718 WESTHEIMER, SUITE 1800, HOUSTON, TX, 77057, US

(73) Assignee: AGENCY FOR SCIENCE, TECHNOLOGY AND RESEARCH, CENTROS (SG)

(21) Appl. No.: 11/791,567

(22) PCT Filed: Nov. 26, 2004
(86) PCT No.: PCT/SG04/00374

§ 371 Date: May 16, 2008

(51) Int. Cl. B26F 1/14; B05D 3/12; C25D 5/34; B05C 21/00; C25D 17/00; B26F 1/24

(52) U.S. Cl. 72/355.4; 427/239; 205/131; 118/37; 204/242

(57) ABSTRACT

A method of micro forming an array of microstructures comprising: advancing a punch having an array of protrusions (620) towards a sheet of material (640) disposed between the punch (620) and a die (630), each protrusion (625) shaped to deform the sheet of material (640) into a corresponding microstructure; providing a holder for holding the sheet of material (640) in place; and punching the sheet of material (640) with the protrusions on the punch (620) to form the array of microstructures on the sheet of material (640).

### FIELD OF INVENTION

The present invention relates broadly to a method and apparatus for microforming an array of microstructures.

### BACKGROUND

Microstructures such as e.g. microneedles are being utilised in a number of different technology areas. For example, hypodermic injection and oral administration are the most commonly practised methods to administer drugs to the human body, due to their rapidness, effectiveness and straightforwardness. Some disadvantages of these methods include initial spike concentration, trauma from hypodermic injection, damage of the drugs in the digestive tract or complications arising at parts of the body other than targeted organs when the drugs are administered orally. On the other hand, transdermal drug delivery, an alternative for hypodermic injection or intravenous infusion, is a painless means to administer drugs to human body. This alternative drug delivery means prevents the drug from being destroyed in the digestive tract or immediately absorbed by the liver. The conventional products for transdermal drug delivery usually come in the form of patches that can be adhered to the human body for prolonged drug delivery without restricting the mobility of the patient. These products usually have drug reservoirs sandwiched between an impervious backing and a membrane face that controls the steady state rate of drug delivery. Some existing applications of transdermal drug delivery include scopolamine for the prevention of motion sickness, nicotine patches for aid in smoking cessation, nitroglycerin for the treatment of coronary angina pain, and estrogen for hormonal replacement.

Transdermal drug delivery systems can generally be classified into active transport systems and passive diffusion systems. Active transport systems incorporate external methods such as, iontophoresis, electroporation and ultrasound to increase drug migration across the skin barrier into human body. These methods enhance diffusion of the medication by electrical means or by the application of high-frequency electrical pulses or sound waves to the skin to improve absorption of a drug. Conventional devices for practising the foregoing methods have not been commercially successful due to high equipment and operations costs and the inconvenience of having to provide portable electrical equipment.

Transdermal patches mentioned above are examples of passive diffusion systems whose functionality is based on the diffusion of chemicals into and through the skin and are dependent on parameters such as porosity of skin, size and polarity of drug molecules, the concentration gradient across the stratum corneum (the outermost layer of human skin), etc. In general, conventional transdermal patches suffer from low diffusion rate of the drugs from the patch through the skin.

One method to improve the diffusion rate is by disruption of the skin (stratum corneum) to upset the diffusion barrier. This may be done either by scratching or by direct penetration of the skin, utilising solid or hollow sharp protrusions, for example, microneedle arrays. This is an effective and inexpensive method for overcoming or ameliorating the low diffusion problem generally faced in transdermal drug delivery.

Conventional methods for producing microneedle arrays include, for example, using a silicon substrate in conjunction with metal deposition and injection molding. Such methods involve high production costs and time and are unsuitable for mass production.

### SUMMARY

In accordance with a first aspect of the present invention there is provided a method of microforming an array of microstructures comprising advancing a punch having an array of protrusions towards a sheet of material disposed between the punch and a die, each protrusion shaped to deform the sheet of material into a corresponding microstructure; providing a holder for holding the sheet of material in place; and punching the sheet of material with the protrusions on the punch to form the array of microstructures on the sheet of material.

The microstructures may be microneedles.

The method may further comprise providing a substantially constant counteractive support on the sheet of material in areas of the respective microstructures during microforming.

The substantially constant counteractive support may be provided by the die.

The die may be a deformable die.

An aspect ratio of the punch may be chosen such that for a given thickness of the sheet of material, plane stress is reduced or avoided in the sheet of material during forming of the microstructures.

Each microstructure may be formed with a solid tip.

Each microstructure may formed with a hole at a tip thereof.

The curvature of the tip of each of the protrusions of the punch may be chosen such that for a given thickness of the sheet of material, a hole or crack are created at an early stage of microforming, wherein the hole or crack subsequently expand during microforming and result in an opening at the tip of each of the microstructures.

The deformable die may be made from a material that recovers partially or substantially after deformation.

The material may comprise semi-crystalline polymeric materials.

The deformable die may be made of a material selected from the group consisting of High Density Polyethylene (HOPE), Polypropylene (PP), Teflon (Polytetrafluoroethylene, PTFE), and Polyethylene terephthalate (PET).

The method may further comprise applying a solid lubricant to the punch.

The solid lubricant may comprise a tetrahedral-amorphous carbon (Ta-C) coating.

The method may further comprise coating on an inner surface of each of the microstructures for hardening the microstructures.

The step of coating may comprise an electroplating process.

The electroplating process may comprise nickel plating.

The sheet of material may be a metallic material chosen from the group consisting of: steel, aluminium 1100 and copper (99%).

In accordance with a second aspect of the present invention there is provided an apparatus for microforming an array of microstructures comprising a punch having an array of protrusions; a die; and a holder for holding a sheet of material in place during microforming, wherein each protrusion is shaped to deform the sheet of material into a corresponding microstructure, and wherein the sheet of material is punched with the array of protrusions to form the array of microstructures.

The microstructures may be microneedles.

A substantially constant counteractive support may be provided to the sheet of material in areas of the respective microstructures during microforming.

The substantially constant counteractive support is provided by the die.

The die may be a deformable die.

An aspect ratio of the punch may be chosen such that for a given thickness of the sheet of material, plane stress is reduced or avoided in the sheet of material during forming of the microstructures.

Each microstructure may be formed with a solid tip.

Each microstructure may be formed with a hole at a tip thereof.

The curvature of the tip of each of the protrusions of the punch is chosen such that for a given thickness of the sheet of material, a hole or crack are created at an early stage of microforming, wherein the hole or crack subsequently expand during microforming and result in an opening at the tip of each of the microstructures.

The deformable die may be made from a material that recovers partially or substantially after deformation.

The material may comprise semi-crystalline polymeric materials.

The deformable die may made of a material selected from the group consisting of: High Density Polyethylene (HOPE), Polypropylene (PP), Teflon (Polytetrafluoroethylene, PTFE), and Polyethylene terephthalate (PET).

A solid lubricant may be applied to the punch.

The solid lubricant may comprise a Ta-C coating.

The apparatus may further comprise means for coating on an inner surface of each of the microstructures for hardening the microstructures.

The coating may comprise an electroplating process.

The electroplating process comprises nickel plating.

The sheet of material may be a metallic material chosen from the group consisting of: steel, aluminium 1100 and copper (99%).

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1(a) shows an exploded perspective view of an apparatus for forming microneedles, according to an embodiment;

FIG. 1(b) shows a perspective view of the apparatus in FIG. 1;

FIG. 2(a) shows a punch that is fabricated by milling, in accordance with another embodiment;

FIG. 2(b) shows a plurality of the punches in FIG. 2(a);

FIG. 2(c) shows a punch that is fabricated by EDM, in accordance with another embodiment;

FIG. 2(d) shows the stereoscopic view of a 6×6 punch array that is fabricated by precision wirecutting, in accordance with another embodiment

FIG. 2(e) shows the side view of the punch array in FIG. 2(d);

FIGS. 3(a) to 3(e) show a schematic representation of a process flow for fabricating microneedles by microforming, according to another embodiment;

FIG. 4 shows a Scanning Electron Microscope (SEM) micrograph of a microneedle with an aspect ratio of about 1.2, in accordance with another embodiment;

FIG. 5 is a SEM micrograph of the microneedle, in accordance with another embodiment;

FIGS. 6(a)-6(e) is a schematic representation of the process flow of fabricating microneedles by microforming, according to another embodiment;

FIGS. 7(a)-7(e) are a schematic representation of a process flow for fabricating microneedles by microforming, according to another embodiment;

FIG. 8(a) is a SEM micrograph of an of the microneedle in accordance with another embodiment;

FIG. 8(b) is a magnified photograph of the microneedle in FIG. 8(a);

FIG. 9(a) is a photograph showing an array of microneedles formed in accordance with another embodiment;

FIG. 9(b) is a photograph showing an array of microneedles formed in accordance with another embodiment;

FIGS. 10(a) and 10(b) are photographs showing the perspective view and cross-sectional view, respectively, of the microneedle, in accordance with another embodiment;

FIGS. 11(a) and 11(b) show the perspective view and cross-sectional view, respectively, of the microneedle, in accordance with another embodiment;

FIGS. 12(a) and 12(b) show the perspective view and cross-sectional view, respectively, of the microneedle, in accordance with another embodiment;

FIGS. 13(a) and 13(b) are photographs of a plan view and an isometric view, respectively, of the microneedle array, in accordance with another embodiment;

FIGS. 14(a) and 14(b) show example microneedle arrays formed by wirecut punch arrays that have aspect ratios ranging from 1 to 1.5;

FIGS. 15(a)-15(c) are SEM micrographs showing the cross sections of the whole microneedle, the base portion of the microneedle, and the tip (apex) of the microneedle, respectively, in accordance with another embodiment;

FIG. 16(a) is a SEM micrograph of the cross section of a microneedle, in accordance with another embodiment;

FIG. 16(b) is a SEM micrograph of the cross section of a microneedle, in accordance with another embodiment;

FIG. 17(a)-17(c) are SEM micrographs of example hollow microneedles fabricated using different thickness of aluminium sheet and punch geometry;

FIG. 17(d) is an isometric view of the hollow microneedle in FIG. 19(c);

FIGS. 18(a) to 18(d) show a schematic representation of the process of fabricating microneedles, in accordance with another embodiment;

FIG. 19(a) shows the microneedle array formed in accordance with the embodiment in FIGS. 18(a) to 18(d);

FIGS. 20(a) to 20(c) show three modes of failure, namely a cap mode, a crown mode and a crater mode, respectively, of the microneedles fabricated by microforming.

### DETAILED DESCRIPTION

Generally, the described embodiments relate to the fabrication of microstructures, for example, microneedles, using microforming. The microneedles may be in the form of arrays and may be used in transdermal drug delivery systems to administer drugs into a living organism or to extract body fluids from a living organism.

Microforming may be defined as the production of parts or structures by metal forming, with at least two dimensions in the sub-millimetre range. Generally, microforming may be viewed as a down-scaling of the conventional metal forming process, both of which may be characterised by four main components, namely—material involved, tools employed, process incorporated and machine used. The material involved is a significant factor. Material related problems associated with the down-scaling of conventional metal forming are strongly coupled with miniaturisation itself: (a) the microstructure, for example, is independent of the dimensions of the process; and (b) the topography of the surface is invariant. These factors lead to the so-called size effects in which the ratio of the dimensions of a part to parameters of the microstructure, such as grain size, or surface changes with miniaturisation. All these factors prevent or obstruct the application of the know-how of conventional metal forming processes in the field of microforming.

The technical implications of microforming are that the flow stress, the vertical mean anisotropy and the ductility are decreased, progressively reducing the formability limit. Investigations have also shown that friction increases with miniaturisation in the case of lubrication with oil, while friction is size-independent in the case of dry forming.

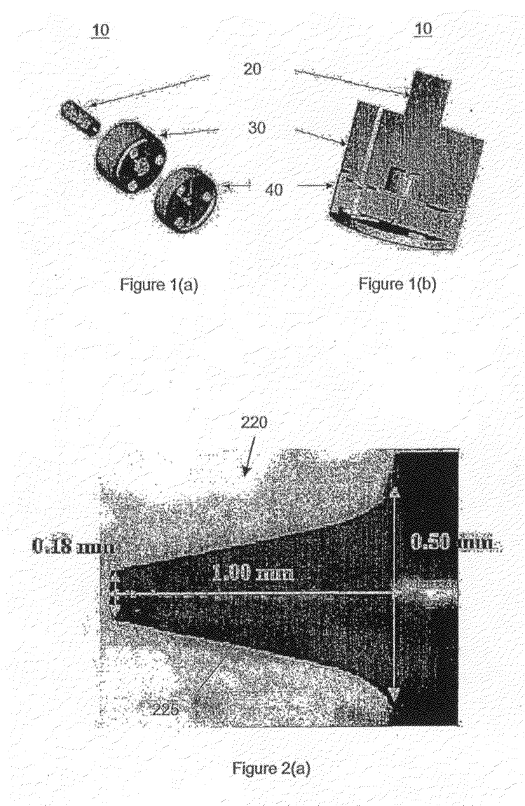

An example embodiment of an apparatus 10 used for microforming is shown in FIG. 1(a) and FIG. 1(b). FIG. 1(a) shows an exploded perspective view of the apparatus 10. The apparatus 10 comprises a punch 20, a holder 30 and a die 40. In this embodiment, the punch 20, the holder 30 and the die 40 are cylindrical. However, it should be appreciated that they may be of any other shape. FIG. 1(b) shows a cross-section of a perspective view of the apparatus 10 when the punch 20, holder 30 and die 40 are assembled together. The apparatus 10 may be operated by various means, for example, a stamping machine or even by hands. Alternatively, a servo press machine may be adapted to operate the apparatus 10 to carry out the fabrication procedure in a more precise manner. Example operating ranges of the servo press machine may be between 5N-500N for punch load and from 0.1 mm/s-35 mm/s for punch speed. The punch load and punch speed may increase in accordance with the size of the microneedle array that is desired.

The punch 20 and the die 30 may be fabricated by various methods, for example, milling, electro-discharge machining (EDM), or by precision wire cutting. The die 30 may be fabricated, for example, by wirecutting to form through-holes in the die. On the other hand, if through-holes in the die are not required, the die may be fabricated by EDM.

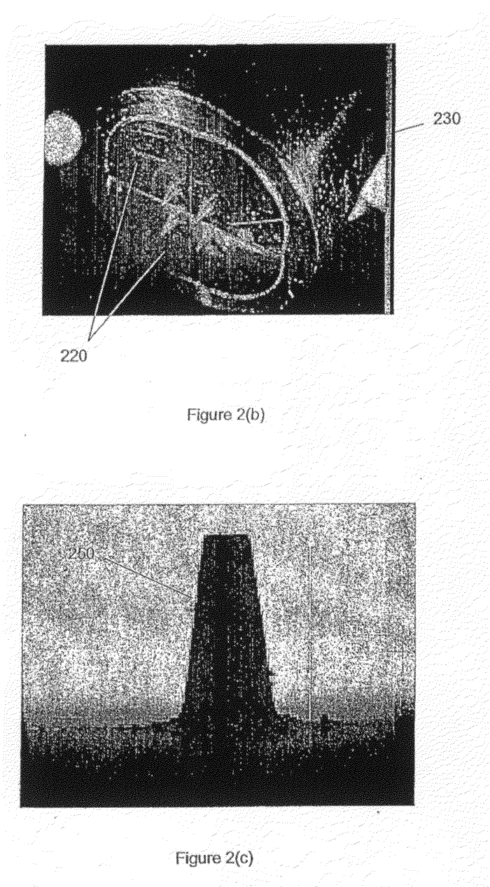

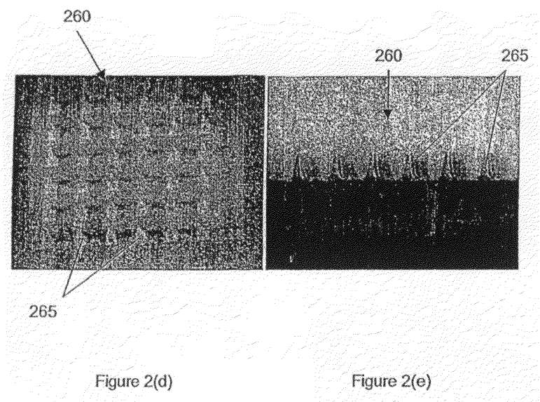

FIG. 2(a) shows a punch 220 with a conical-shaped protrusion 225 fabricated by milling, in accordance with another embodiment. The surface finish of the punch 200 was observed to be satisfactory for consistent results, which typically is strongly dependent upon retracting of the punch after forming of the microneedles (or microstructures). For example, a surface roughness (surface finish) obtained of conventional CNC mill finish suffices for most applications that have larger dimensions, for example, more than about 500 microns. For forming structures that are, for example, less than about 100 microns, it is observed that the average surface roughness required is less than about 0.1 microns. Further, if a solid lubricant is used the surface roughness requirement may be relaxed to less than about 0.5 to 0.1 micron. An array of punches 220 may be obtained by milling and trimming each of the punches 220 separately before mounting the punches 220 to the punch holder 230, as shown in FIG. 2(b). In this embodiment, four punches 220 are mounted to the punch holder 230 to form a 2×2 array of punches 220. FIG. 2(c) shows a punch 250 fabricated by EDM, in accordance with another embodiment. It was observed that the surface finish of the punch 250 fabricated from EDM was moderate compared to milling or precision wirecutting.

FIGS. 2(d) and 2(e) show a stereoscopic view and side view, respectively, of a 6×6 punch array 260 fabricated by precision wirecutting, in accordance with another embodiment. The punches 265 were produced with three passes of cutting and the approximate dimensions of the base and height of each of the punches 265 is 0.25 mm and 0.75 mm, respectively. The wirecutting process imposes an inherent finite curvature at the base of the punch 265 and hence the base of a microneedle (not shown in FIGS. 2(a) to 2(e)) due to the radius of the wire used. Nevertheless, these radii at the outer base of the needles, which can be seen in FIG. 21 (b), strengthen the punch structure by avoiding sharp edges.

In the example embodiments, the punch (and therefore the die) has tapered walls allowing punch retraction during microforming. Further, as a blanking or piercing process takes place along with forming, some degree of tapering of the walls of the punch is required so as to plastically deform and conform the material into the punch shape.

In the above embodiments, the punch has a substantially circular cross-section. However, a variety of shapes, for example, triangular, rectangular or octagonal, etc are also possible, depending on the application.

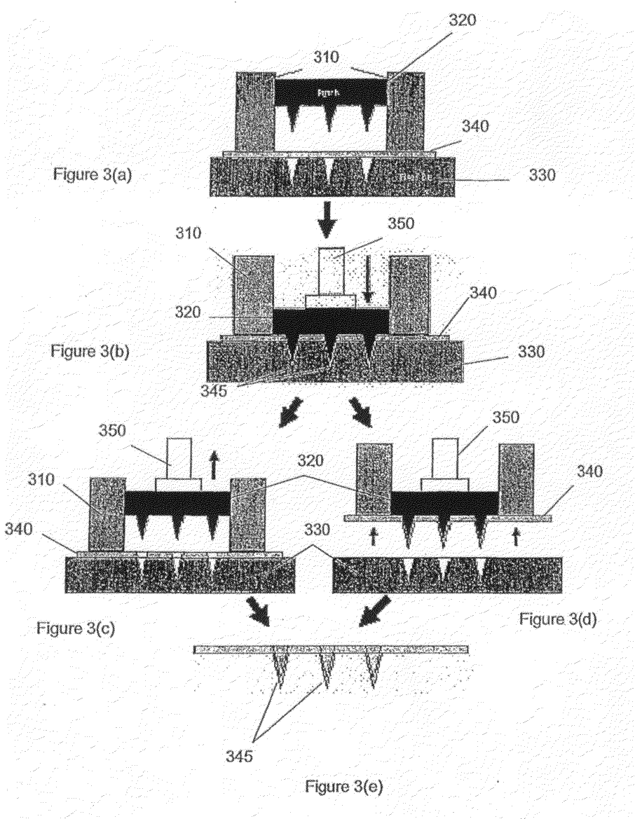

FIGS. 3(a)-3(e) are a schematic representation of the process flow of fabricating microneedles by microforming, according to another example embodiment. A metal sheet 340 is placed in between a punch array 320 and a fixed die 330. A holder 310 is placed on top of the metal sheet 340 to prevent movement of the metal sheet 340 during the microforming process and to prevent wrinkling of the metal sheet 340. Additional clamping (not shown) of the metal sheet 340 to the fixed die 330 may be necessary to further constrain the metal sheet 340 so as to prevent warping and wrinkling. The metal sheet 340 may be made of metallic materials such as steel 304, aluminium 1100, and copper (99%). The metal sheet 340 should sufficiently cover and overlay the affected region (the diameter of the die 330) in such a way that the smallest length of the metal sheet 340 exceeds approximately 5 times the diameter of the die 330.

A ram 350 is set to bring down the punch array at an appropriate speed, subsequently forming an array of microneedles 345 on the metal sheet 340, as shown in FIG. 3(b). In this embodiment, the punch 320 has an array of conical shaped protrusions 325 and the die 330 has a negative pattern corresponding to the conical shaped protrusions 325 on the punch 320. The geometry of the microneedles 345 formed correspond to the geometry of the punch 320 and the die 330. After forming the microneedles 345 on the metal sheet 340, the punch 320 is retracted by the ram 350. The punch 320 may be retracted such that the metal sheet 340 with the formed array of microneedles 345 remain on the die, as shown in FIG. 3(c). Alternatively, the punch 320 may be retracted such that the holder 310 and the metal sheet 340 with the formed array of microneedles 345 remain on the punch 320, as shown in FIG. 3(d). Finally, the formed microneedles 345 can be detached from either the punch array 320 or the fixed die 330, depending on the design and variance of the apparatus (FIG. 3(e)). It should be noted that a larger punch load may be required for a larger microneedle array. It is observed that the increase in the punch load is almost proportionate to the number of microneedles in the microneedle array being formed.

Friction plays a major role in punch retraction in that the formed microneedles 345 may be damaged during a retraction stroke. To prevent damage of microneedles by punch retraction, a lubricant coating may be applied to the punch (not shown).

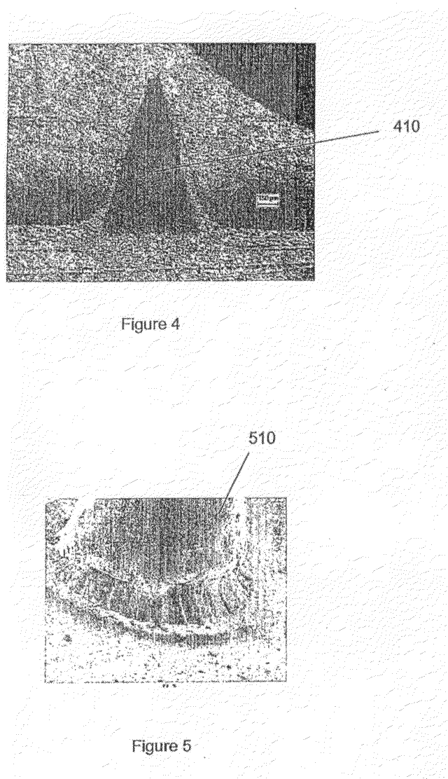

In another example embodiment, a solid lubricant such as Ta-C, which is a diamond-like carbon coating with a thickness of about 2 microns, is applied to the punch. FIG. 4 shows a Scanning Electron Microscope (SEM) micrograph of a microneedle 410 with an aspect ratio of about 1.2 that was microformed on an approximately 0.15 mm thick aluminium sheet (99% pure), using an approximately 6 mm thick High Density Polyethylene (HOPE) pad as the die (not shown). The base diameter of the punch (not shown) was 1 mm, while its height was about 1.5 mm, giving an aspect ratio of about 1.5 (after the tip of the punch is round out, the actual height is roughly 1.45 mm). Rounding out the tip of the punch enables a solid microneedle to be obtained without an opening or to delay the rupture and hole expansion process.

FIG. 5 is an SEM micrograph of a microneedle 510 formed in accordance with another embodiment, showing the retro punching effect on a foot radius of the microneedle 510, which was forcefully scratched off leaving an ‘over-etched effect. The microneedle 510 was formed using an approximately 0.15 mm thick aluminium sheet (99% pure) subjected to a punch (not shown) having dimensions of about 0.5 mm in base diameter and about 1 mm in height. A strip spanning the base of the inner surface of the microneedle 510 was a burr-like artefact generated and accumulated during grinding process. The formed microneedle 510 was then retro punched by a female punch (not shown), which essentially was a tapered cavity. The retro punching step significantly reduces the foot radius of the microneedle 510, and hence resulting in the microneedle 510 having an aspect ratio about 1.4. Despite this considerable reduction in dimensions, the thickness of the microneedle 510 is sufficiently large to sustain mechanical load during handling and skin penetration. This also illustrates how microformed microneedles can be further patterned on their lateral surfaces to facilitate skin penetration. For example, corrugated fine lines or other patterns that sharpens the microneedles may be formed or engraved onto an outer surface of each of the microneedles to facilitate skin penetration.

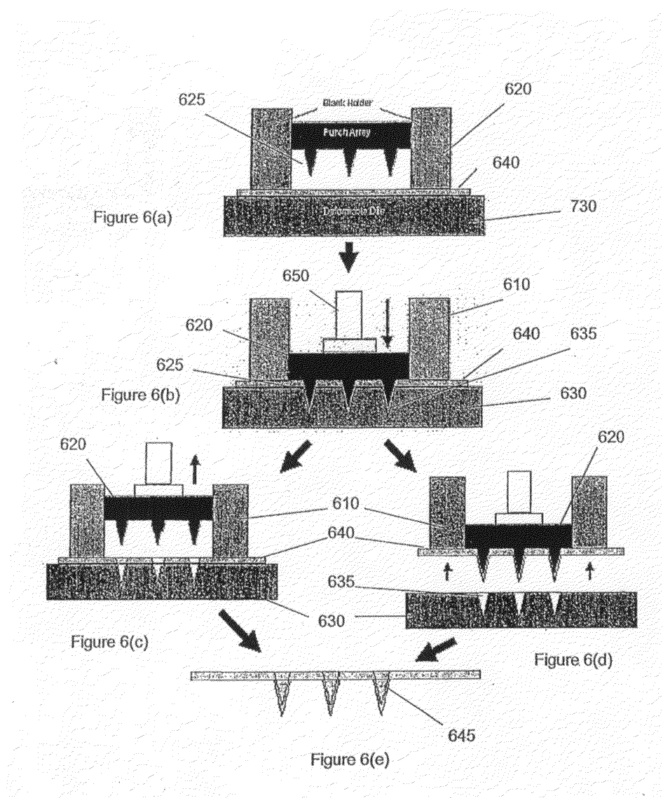

FIGS. 6(a)-6(e) is a schematic representation of the process flow of fabricating microneedles by microforming, according to another example embodiment. In this embodiment, the fixed die 330 in FIGS. 3(a) to 3(e) is replaced with a deformable die 630. The deformable die 630 may be made in the form of a sheet made from soft materials that are deformable, for example, semi-crystalline polymers, such as, High Density Polyethylene (HOPE), Polypropylene (PP), Teflon (Polytetrafluoroethylene, PTFE), Polyethylene terephthalate (PET), etc., which are usually stronger and more resistant to dissolution and softening by heat compared to amorphous polymers. It should be appreciated that the material used for the deformable die 630 should recover partially or substantially after being pierced by the punch 620 to enable the deformable die 630 to be re-used. The deformable die 630 allows continuous flow of material as the punch 620 advances, thus preventing necking of the microneedles 645 by stretching during the microforming process. Compared to the fixed die 330 in FIGS. 3(a) to 3(e), a negative of the shape of the protrusions 625 on the punch 620 need not be formed on the deformable die 630 prior to microforming.

The punch 620 may be coated with a solid lubricant, for example Ta-C. The punch 620 is lowered and is pressed against the metal sheet 640 that sits on the deformable die 630 as shown in FIG. 6(b). At the same time, the deformable die 630 is pierced by the punch 620 and forms cavities 635 corresponding to the negative of the shape of the protrusions 625 on the punch 620. The movement of the punch 620 is stopped when full length of the microneedles 645 is achieved. Similarly, the formed microneedles 645 can be detached from either the punch 620 or the deformable die 630 according to process design and variance. The ease of removal of the formed microneedles 645 depends on the forming pressure and the properties of the polymeric material used for the deformable die 630 and the metal sheet 640. Although the cavities 635 are formed permanently in the deformable die 630, the cavities 635 shrink and recover sufficiently to enable the deformable die 630 to be re-used. This is due to the nature of the material used for the deformable die 630.

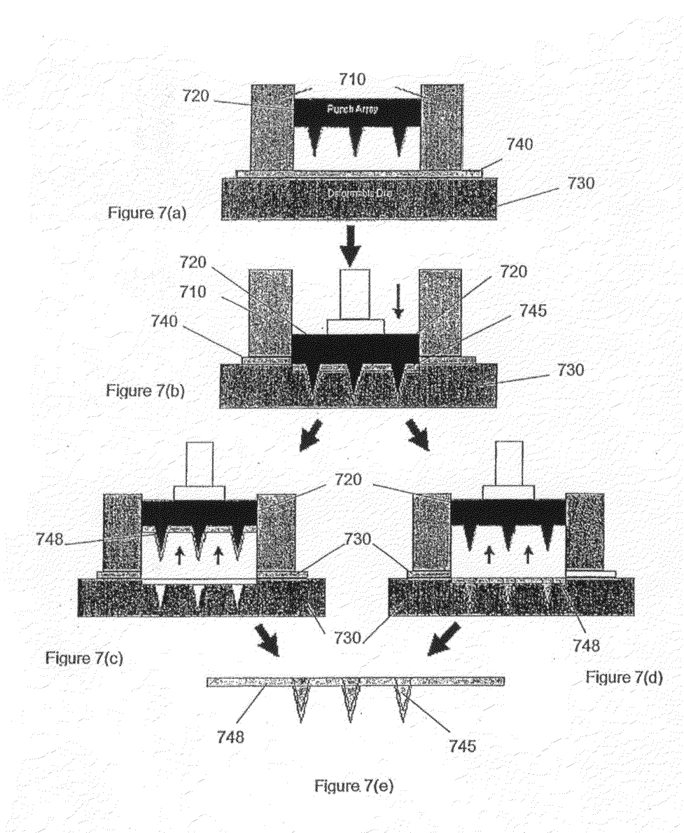

FIGS. 7(a)-7(e) are a schematic representation of a process flow of fabricating microneedles by microforming, according to another example embodiment. In this embodiment, the solid-lubricated punch 720 is pressed against the metal sheet 740 that is disposed on the polymeric deformable die 730. After achieving the full length of the microneedles 745, the punch 720 is further advanced, by applying additional pressure to stamp out the formed microneedle array 748 from the rest of the metal sheet 740, shown in FIGS. 7(c) and 7(d). The formed microneedle array 748 may be attached to the retracted punch 720 (FIG. 7(c)) or remain on the deformable die 730 (FIG. 7(d)), depending on process design and variance, and removed accordingly to obtain the microneedle array 748 as shown in FIG. 7(e).

It is observed that the two roles a die will typically play in conventional metal forming, namely, to deform the blank particularly at the die shoulder into three dimensional structures, and/or to act as an “iron board” at the lateral body of the structures during the forming process to ensure accurate thinning of the material by an ironing effect, do not generally apply to microforming. It is observed that forming of microneedles depends on the design of the punch, in particular, the aspect ratio of the punch and the thickness of the sheet of material used for forming the microneedles. It is also observed that a counteractive support on the sheet of material delays premature failure of the microneedles during the forming process. In general, it was observed that a thin material sheet resulted in an improved shape conformance to the punch geometry at the outer surface of the microneedles, compared to a thicker sheet of material, although both thin and thick material sheets strictly conformed to the punch geometry at the contacting surface between the punch and the material sheet during microforming. Generally, the material sheet is considered as thin if the thickness of the material sheet is about 5-10 times smaller than the height of the punch.

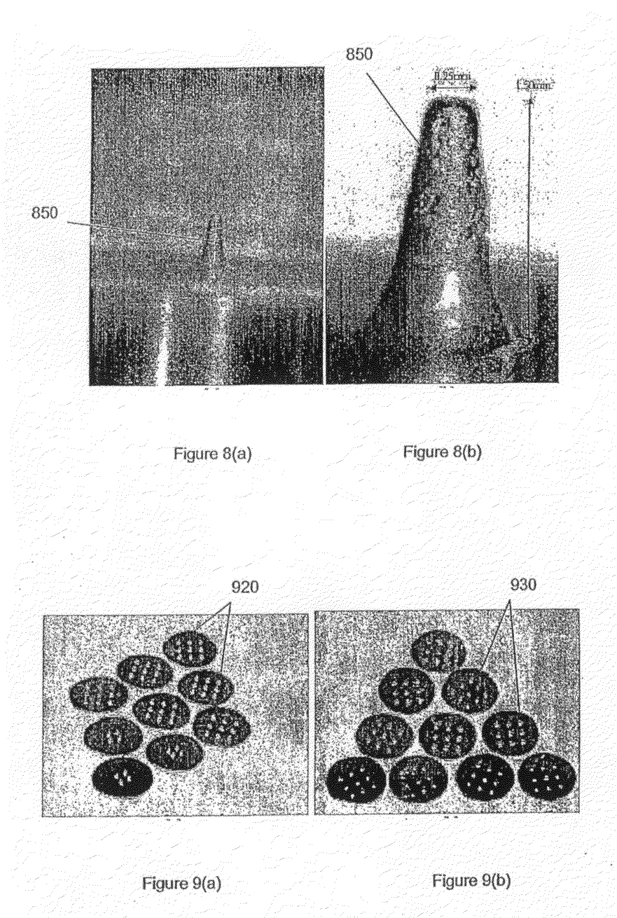

A constant counteractive support on the material sheet during microforming may be provided by the deformable die 630, 730, for example, as described in the example embodiment in FIGS. 6(a)-6(e) and FIGS. 7(a)-7(e). FIG. 8(a) shows a SEM micrograph of an example embodiment of the microneedle 850 formed using an approximately 0.2 mm thick aluminium sheet (1100) using a punch (not shown) with an aspect ratio equal to approximately 3 (without retracting the punch). FIG. 8(b) is a magnified photograph of the microneedle 850, with the approximate dimensions indicated. A solid lubricant, such as a diamond-like carbon coating, for example, a tetrahedral-amorphous carbon coating, may be coated on the punch to reduce friction which may cause the microneedle 850 to be damaged during retraction of the punch. Alternatively, the surface roughness of the punch may be improved to reduce friction and contact between the punch and the material sheet and to minimise interfacial adhesion between the material and the punch. In this example embodiment the punch was made of hardened tool steel, and the sheet material for forming the microneedle 850 was made of aluminium. One possible reason for the failure of the microneedle 850 when the punch is retracted may be the high deformation the material sheet was subjected to during microforming.

Further, an advantage of using a deformable die is that it can be used as a universal die for stamping purposes at slightly elevated pressures, for example, at pressures that are about 10%-50% of the forming pressure. FIGS. 9(a) and 9(b) show photographs of example arrays of microneedles 920, 930 that were formed and stamped out of an approximately 0.15 mm thick aluminium sheet using a deformable polymeric die (not shown). It was observed that the arrays of microneedles 920, 930 exhibit the superior capability of a deformable die as compared with a rigid die, which requires high fabrication costs especially when a large array of such unit dies with complex geometry are required.

Size effects originate from the fact that a material's microstructure does not change when the work piece is scaled down. The microstructure of the sheet material used for microforming microneedles was examined at different locations of a specimen, namely at the waist (middle of height) of the microneedle where extensive stretching was experienced, and at the base area far from the microneedle where no deformation was experienced. Observation of grain sizes of deformed and un-deformed areas implies that such deformation can be carried out without causing significant changes in the microstructure of the material, which has a typical average grain size in the region of tens of nanometers. The thickness of material used for forming the microneedles plays a vital role in obtaining microneedles with high aspect ratios. For example, using a very thick sheet of material, e.g. ratio of the punch height to the thickness of the material of less than about 4, will not form well-defined needles, or using a sheet that is too thin compared to the punch size, e.g. ratio of the punch height to the thickness of the material of greater than about 20, will lead to plane stress phenomenon where piercing or blanking process takes place, forming only holes instead of microneedles. It was observed that as the punch size is reduced, the thickness of the material sheet needs to reduce as well, but this downscaling is linear. It was observed that there is an optimal range of material thickness where a punch with a particular geometry can form satisfactory microneedles, with the support of a deformable die.

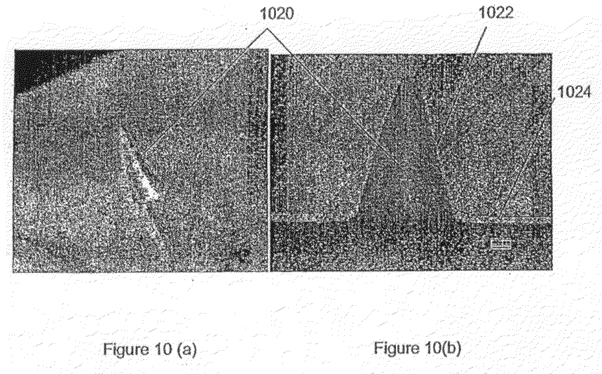

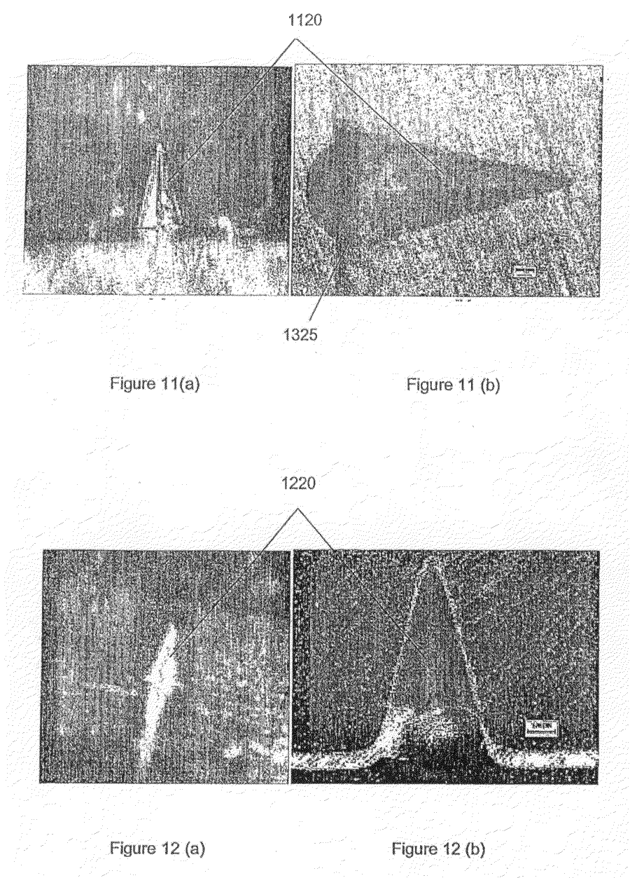

FIGS. 10 (a), 10(b), 11(a), 11(b), 12(a) and 12(b) show example embodiments of microneedles obtained from an approximately 50 micron thick aluminium sheet. FIGS. 10(a) and 10(b) are photographs showing the perspective view and cross-sectional view, respectively, of the microneedle 1020 and was formed using the punch (not shown) having 1 mm base diameter and 1.5 mm height (i.e. aspect ratio of 1.5). It was observed that the wall thickness 1022 of the microneedle 1020 was reduced to approximately more than half of the original sheet thickness 1024. FIGS. 11(a) and 11(b) show the perspective view and cross-sectional view, respectively, of the microneedle 1120 formed with the punch (not shown) having an aspect ratio of about 2 and an approximately 1 mm base. A burr-like fin 1125 at the bottom of the cross section was due to grinding. FIGS. 12(a) and 12(b) show the perspective view and cross-sectional view, respectively, of the microneedle 1220 formed with the punch (not shown) with an approximately 0.5 mm base diameter and approximately 1 mm in height (i.e. aspect ratio of approximately 2). The tip (apex) of the microneedle 1220 and the average wall thickness are roughly in the range of 20-30 and 15-30 microns, respectively.

The requirement of a thinner material sheet for making smaller microneedles imposes a lower limit on the wall thickness of the formed microneedles as the wall thickness of the formed needles may be reduced to between half and one fifth of the original blank thickness, making the needles unsuitable for practical purposes. If the required microneedle size is very small, e.g. less than about 150 microns in base dimensions, the optimum material thickness required is very thin. This results in a soft platform of microneedle arrays that may be subject to bending and deformation. This reduction in size and thickness results in weak microneedles which are not reliable. This problem may be overcome by electroforming a layer of material such as nickel as a microneedle to increase the total thickness of the microneedle, thereby strengthening the microneedle. Alternatively, a microneedle may be anodised to form a layer of alumina that is hard and brittle.

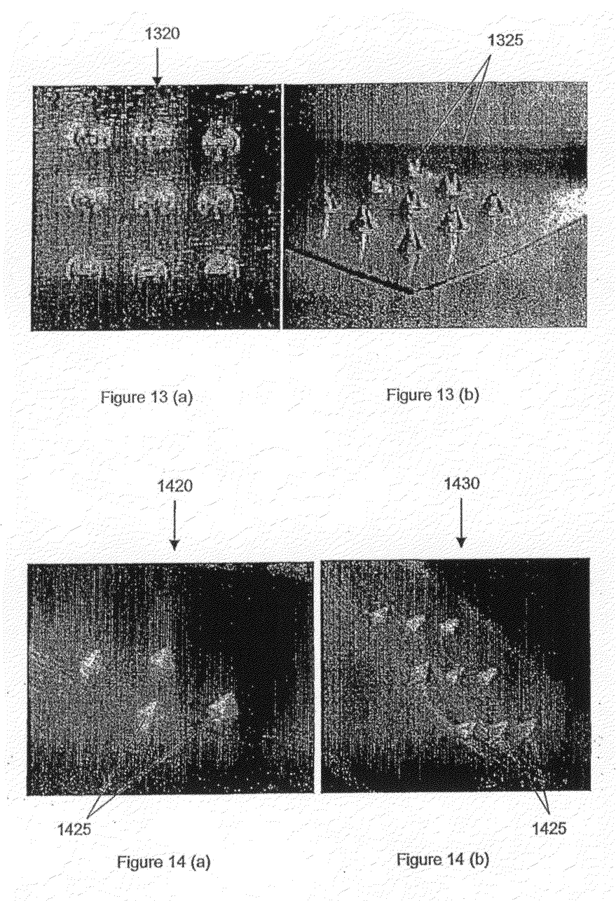

One way to fabricate an array of microneedles array may be to use a single punch (not shown) repeatedly to form each needle in the array separately on a material sheet. FIGS. 13(a) and 13(b) are photographs of a plan view and an isometric view, respectively, of an example embodiment of the microneedle array 1320 formed using a single punch (not shown). It is observed that no significant deformation takes place around the microneedle, thus, adjacent microneedles 1325 may be formed in close proximity to another.

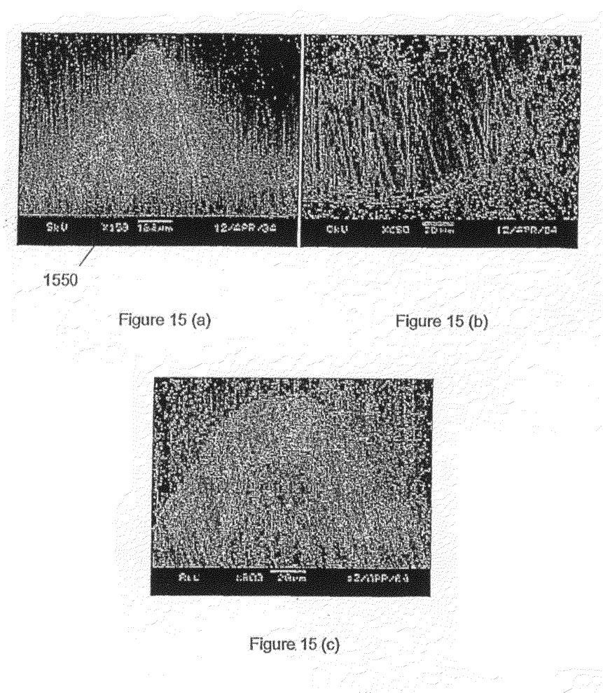

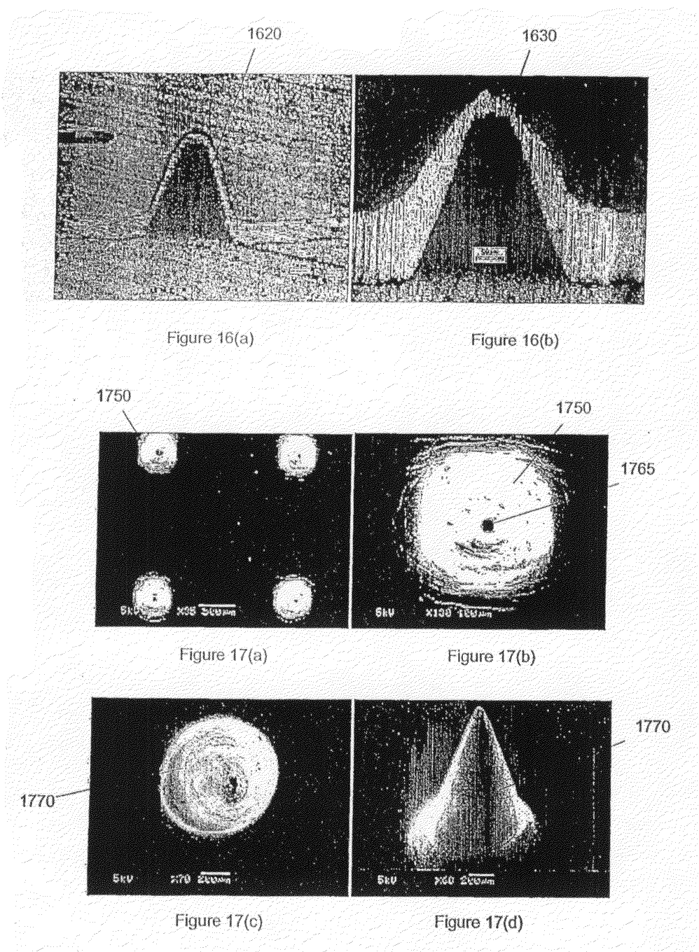

FIGS. 14(a) and 14(b) show example microneedle arrays 1420, 1430 formed by wirecut punch arrays (not shown) that have aspect ratios ranging from 1 to 1.5. These punch arrays were wirecut with three passes to ensure a satisfactory surface finish, and coated with solid lubricant of about 2 micron thickness. Each of the microneedles 1420, 1430 has a base diameter of approximately 0.5 mm, and the height of the microneedles is about 0.5 mm for the 2×2 microneedle array 1420 (FIG. 16(a)) and about 0.75 mm for the 3×3 microneedle array 1430, respectively. The thickness of the aluminium sheet (1100) used for forming the microneedle arrays 1420, 1430 was about 50 microns in thickness. The final wall thickness of the microneedles 1425, 1435 were between about 8 to 20 microns. The final wall thickness may be increased further by anodising, or electroplating/depositing the outer surface of the microneedles 1425, 1435 with nickel or other metallic/non-metallic materials, including e.g. polymeric materials. Further, both sides of the microneedle arrays 1420, 1430 may be anodised with a layer of aluminium oxide to harden the microneedle arrays 1420, 1430. After anodising the microneedle arrays 1420, 1430 in oxalic acid 5% for 3 minutes at a constant voltage of 45V (effective area of roughly 10×10 mm²), the wall thickness of the microneedles 1425, 1435 was increased from about 20 microns to about 30 microns. FIGS. 15(a)-15(c) are SEM micrographs showing the cross sections of the whole microneedle 1550, the base portion of the microneedle 1550, and the tip (apex) of the microneedle 1550, respectively, in accordance with another embodiment. The example microneedle 1550 is part of a 3×3 microneedle array (not shown). It is observed that the microneedle base was subjected to the most deformation, and the tip of the microneedle 1550 was displaced the most after microforming.

In another embodiment, an aluminium sheet of about 0.2 mm was electro-polished in a mixture of perchloric acid (30%) and methanol (pure) based on a ratio of 1:4. A constant voltage of 12.5V was applied for a length of time to obtain a desired thickness of the aluminium sheet. A thickness of 85 microns and a thickness of 130 microns were obtained after electropolishing for 9 and 14 minutes, respectively, after which the aluminium sheet was punched and anodised, yielding aspect ratios of 1.0 and 0.6, respectively, as shown in FIGS. 16(a) and 16(b). It is observed that in both example embodiments, the example microneedles 1620, 1630 as well as the platform of the microneedle arrays (not shown) are strong enough to sustain handling and distorting forces during skin penetration. It is noted that the microneedle 1630 in FIG. 16(b) has a much larger outer foot radius than the microneedle 1620 in FIG. 16(a). This is due to greater thickness of the aluminium sheet (i.e. 130 microns) used in forming the microneedle 1630 in FIG. 16(b) and causes a reduction of about 40% in the aspect ratio of the microneedle 1630.

Both solid and hollow microneedles may be fabricated using an almost similar experimental set-up and materials described in the above embodiments. By controlling the sharpness of the punches at the tip, microneedles may be made solid (without creating a hole during the punch stroke) or hollow (creating and expanding a hole at the tip of punch during punch stroke). The only process variance in yielding solid and hollow microneedles is the sharpness of the punch tip. The tip sharpness of the punch is strictly dependent upon the relative thickness of the metal sheet. Thus, a particular punch tip may be sharp enough for a relatively thick metal sheet but may be too blunt for the same material having a smaller thickness. It is quite straightforward to presume that rounded tips do not generate cracks or fail on the material sheet during the forming stroke, thereby forming solid microneedles. Conversely, hollow microneedles require sharpened tips to create holes or cracks at an early stage of the forming stroke, which expand moderately along the stroke of the punch, resulting in uniform openings at the tip. This hole-creation-and-expansion mechanism is in accordance with the third failure mode, or the crater mode. FIG. 17(a)-17(c) are SEM micrographs of example hollow microneedles fabricated using different thicknesses of aluminium sheet and punch geometry. FIG. 17(a) shows the hollow microneedle array 1750 formed using a punch (not shown) having an aspect ratio of 1.5 and a 0.2 mm thick aluminium sheet. FIG. 17(b) is a plan view of the microneedle 1760 with a 50 micron hollow tip 1765. FIGS. 17(c) and 17(d) is a plan view and an isometric view, respectively, of the hollow microneedle 1770 formed with a punch (not shown) having an aspect ratio of 2.

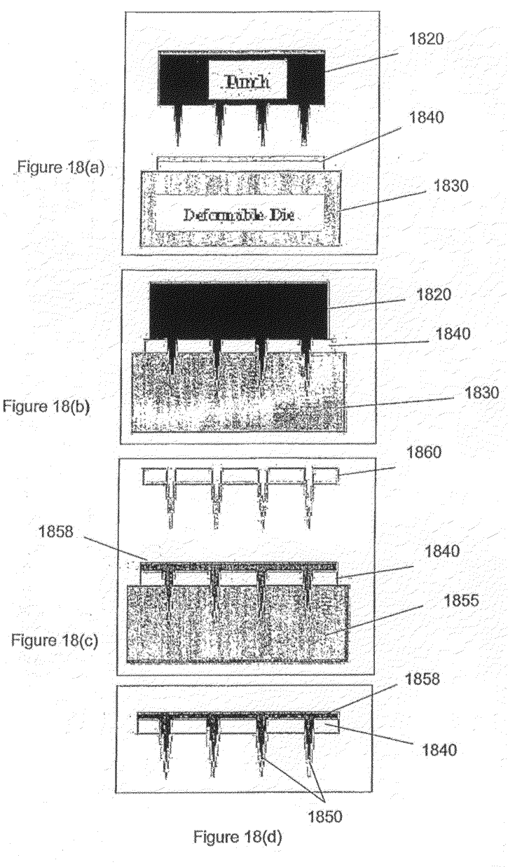

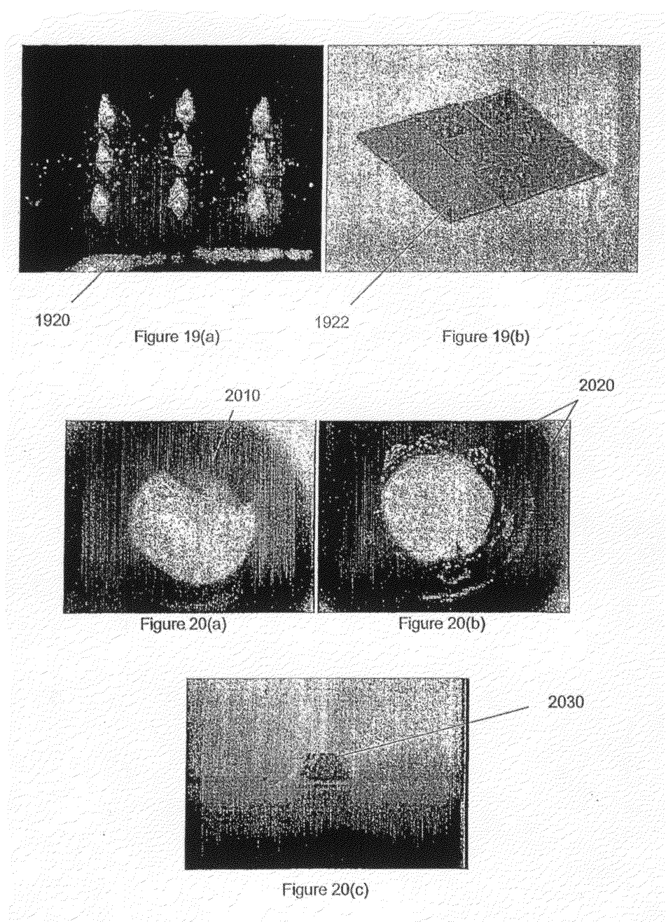

FIGS. 18(a) to 18(d) show a schematic representation of the process of fabricating microneedles 1850, in accordance with another embodiment. The microneedles 1850 are obtained by punching the 50 micron thick aluminium sheet 1840 with the 4×4 punch array 1820. An inner surface of each of the microneedles 1850 is coated by an electroplating process such as nickel plating. A protruding surface 1860 is coated with epoxy 1855 to prevent nickel-plating on an outer surface of the microneedles 1850. The punched microneedle array 1840 was then electroplated in a nickel chloride solution (industrial grade) for 12 hours at constant current 0.08 A, forming a layer of nickel plating 1858, on the inner surface of the microneedles 1850, as shown in FIGS. 18(c) and 18(d). FIG. 19(a) shows the well-defined microneedle array 1920 formed in accordance with the embodiment in FIGS. 18(a) to 18(d). The microneedle array 1920 is slightly bent outward to facilitate skin scratching. FIG. 19(b) shows various example anodised microneedle arrays e.g. 1922, showing differences in thickness, in which the darker greyscale indicates increased thickness.

FIGS. 20(a) to 20(c) show three modes of failure, namely a cap mode, a crown mode and a crater mode, respectively, of the microneedles fabricated by microforming. The type of failure mode depends on the position where necking takes place in the material (overworked). The cap mode failure is generated when necking takes place at the side wall of the formed microneedles, and the crack subsequently propagates circumferentially forming a hemispheric lid 2010 attached to the conical microneedle, as shown in FIG. 20(a). On the other hand, the crown-type failure is caused by radial propagation of cracks generated in the region subjected to the tip of the punch (not shown), and the material sheet involved is usually thin enough compared to the punch size (base diameter) A typical ratio of the thickness of the material sheet with respect to the punch size for the crown-type failure to occur is about 10 or more. The fragmented faces of the microneedle often curl back as the cracks propagate, forming sharp edges 2020 (FIG. 20(b)) which are good for scratching purposes. Lastly, the crater-type failure is a hole-expansion process where a hole is created initially by the punch and subsequently expanded as the punch advances. This mode yields relatively sharp and smooth circumference 2030 at the tip of the microneedle, as shown in FIG. 20(c). The crater-mode failure is used in the formation of hollow microneedles, as described earlier.

In the example embodiments, microforming is used to form microneedles. It should be appreciated that microstructures of other shapes may also be produced in different embodiments.

Using microforming to produce microneedles substantially reduces the production time and cost of such microneedle arrays, thereby making the technology feasible for commercialisation.

Further, embodiments described hereinbefore enable hollow or solid microstructures that have a wide range of lengths and aspect ratios to be microformed such is currently a limiting factor for certain technologies, e.g. silicon technologies. For example, microneedles having a variety of aspect ratios may be obtained by increasing the taper of the punch in conjunction with using an appropriate thickness of metal sheet.

Microforming also enables the fabrication of microneedle arrays with complicated geometry by way of post fabricating processes such as forming, trimming, carving, grinding, hole drilling, electroforming, etc.

Additional processes may be incorporated to further manipulate/optimise the mechanical properties of the microneedles formed or to further improve the geometry of the microneedles.

The present invention may also be applied to other microstructures, including e.g. micro-components used in micro-systems technologies (MST) and electrical and electronic modules, which include pins for IC carriers, micro screws, fasteners, frames, springs, contacting elements such as pads and pins, etc.

It will be appreciated by a person skilled in the art that numerous variations and/or modifications may be made to the present invention as shown in the specific embodiments without departing from the spirit or scope of the invention as broadly defined. The present embodiments are, therefore, to be considered in all respects to be illustrative and not restrictive.

1. A method of microforming an array of microstructures comprising:
advancing a punch having an array of protrusions towards a sheet of material disposed between the punch and a die, each protrusion shaped to deform the sheet of material into a corresponding microstructure;
providing a holder for holding the sheet of material in place; and
punching the sheet of material with the protrusions on the punch to form the array of microstructures on the sheet of material.

2. The method as claimed in claim 1, wherein the microstructures comprise microneedles.

3. The method as claimed in claims 1 or 2, further comprising providing a substantially constant counteractive support on the sheet of material in areas of the respective microstructures during microforming.

4. The method as claimed in claim 3, wherein the substantially constant counteractive support is provided by the die.

5. The method as claimed in claim 4, wherein the die is a deformable die.

6. The method as claimed in claim 1, wherein an aspect ratio of the punch is chosen such that for a given thickness of the sheet of material, plane stress is reduced or avoided in the sheet of material during forming of the microstructures.

7. The method as claimed in claim 1, wherein each microstructure is formed with a solid tip.

8. The method as claimed in claim 1, wherein each microstructure is formed with a hole at a tip thereof.

9. The method as claimed in claim 8, wherein the curvature of the tip of each of the protrusions of the punch is chosen such that for a given thickness of the sheet of material, a hole or crack are created at an early stage of microforming, wherein
said hole or crack subsequently expand during microforming and result in an opening at the tip of each of the microstructures.

10. The method as claimed in claim 5, wherein the deformable die is made from a material that recovers at least partially after deformation.

11. The method as claimed in claim 10, wherein the material comprises semi-crystalline polymeric materials.

12. The method as claimed in claim 10, wherein the deformable die is made of a material selected from the group consisting of: High Density Polyethylene (HOPE), Polypropylene (PP), Teflon (Polytetrafluoroethylene, PTFE), and Polyethylene terephthalate (PET).

13. The method as claimed in claim 1, further comprising applying a solid lubricant to the punch.

14. The method as claimed in claim 13, wherein the solid lubricant comprise a Ta-C coating.

15. The method as claimed in claim 1, further comprising coating on an inner surface of each of the microstructures for hardening the microstructures.

16. The method as claimed in claim 15, wherein the step of coating comprises an electroplating process.

17. The method as claimed in claim 16, wherein the electroplating process comprises nickel plating.

18. The method as claimed in claim 1, wherein the sheet of material is a metallic material chosen from the group consisting of: steel, aluminium 1100 and copper (99%).

19. An apparatus for microforming an array of microstructures comprising:
a punch having an array of protrusions;
a die; and
a holder for holding a sheet of material in place during microforming, wherein each protrusion is shaped to deform the sheet of material into a corresponding microstructure; and wherein the sheet of material is punched with the array of protrusions to form the array of microstructures.

20. The apparatus as claimed in claim 19, wherein the microstructures comprise microneedles.

21. The apparatus as claimed in claims 19 or 20, wherein a substantially constant counteractive support is provided to the sheet of material in areas of the respective microstructures during microforming.

22. The apparatus as claimed in claim 19, wherein the substantially constant counteractive support is provided by the die.

23. The apparatus as claimed in claim 22, wherein the die is a deformable die.

24. The apparatus as claimed in claim 19, wherein an aspect ratio of the punch is chosen such that for a given thickness of the sheet of material, plane stress is reduced or avoided in the sheet of material during forming of the microstructures.

25. The apparatus as claimed in claim 19, wherein each microstructure is formed with a solid tip.

26. The apparatus as claimed in claim 19, wherein each microstructure is formed with a hole at a tip thereof.

27. The apparatus as claimed in claim 26, wherein the curvature of the tip of each of the protrusions of the punch is chosen such that for a given thickness of the sheet of material, a hole or crack are created at an early stage of microforming, wherein
said hole or crack subsequently expand during microforming and result in an opening at the tip of each of the microstructures.

28. The apparatus as claimed in claim 23, wherein the deformable die is made from a material that recovers at least partially after deformation.

29. The apparatus as claimed in claim 28, wherein the material comprises semi-crystalline polymeric materials.

30. The apparatus as claimed in claim 28, wherein the deformable die is made of a material selected from the group consisting of: High Density Polyethylene (HOPE), Polypropylene (PP), Teflon (Polytetrafluoroethylene, PTFE), and Polyethylene terephthalate (PET).

31. The apparatus as claimed in claim 19, wherein a solid lubricant is applied to the punch.

32. The apparatus as claimed in claim 31, wherein the solid lubricant comprise a Ta-C coating.

33. The apparatus as claimed in claim 19, further comprising means for applying a coating on an inner surface of each of the microstructures for hardening the microstructures.

34. The apparatus as claimed in claim 33, wherein the coating comprises an electroplating process.

35. The apparatus as claimed in claim 34, wherein the electroplating process comprises nickel plating.

36. The apparatus as claimed in claim 19, wherein the sheet of material is a metallic material chosen from the group consisting of: steel, aluminium 1100 and copper (99%).
